(19) United States
(12) Patent Application Publication
(10) Pub. No.: US 2013/0288068 A1
(43) Pub. Date: Oct. 31, 2013

(54) WS2

(71) Applicant: John Bernard, Vero Beach, FL (US)

(72) Inventor: John Bernard, Vero Beach, FL (US)

(21) Appl. No.: 13/506,540

(22) Filed: Apr. 26, 2012

(51) Int. Cl. B32B 1/04; B32B 3/04

(52) U.S. Cl. 428/595; 428/122

(57) ABSTRACT

The WS2 is made of a flexible rust resistant galvanized sheet metal, or other material that can be strong and flexible, that is preformed and bent to it permanent shape, which is a rectangular shape with four sides, one of which has a flap which has an outward fold and an adjacent side which has an inward fold. This allows user to hook together the two open sides. The flap and adjacent side have opposite folds that are designed to lock together making WS2 a secure one piece unit.

The WS2 can be flexed open and placed around a wooden post, then to, on its own, snaps shut protecting the post from weed eater damage. There is no folding or unfolding needed. No screws or nails are needed to hold WS2 in place, because of WS2 self locking folds.

### CROSS REFERENCE TO RELATED APP

This patent application claims benefit of related patent application Ser. No. ______

### BACKGROUND

For years there have been mail box posts in front of houses. Since the invention of the weed-eater in around 1972, the wooden mailbox post has been getting whipped up by the plastic weed-eater line. The grass grows next to the mailbox post and when the weed-eater trims the grass around the post it can't help but strike the post with the weed eater line. This causes the post to get chewed up, and whipped away. The WS2 is designed to eliminate this problem.

### SUMMARY

The WS2 is designed as a strong, flexible, per-formed one piece unit, that is easy to install. The user simply flexes open WS2 and places it around the wooden mailbox post, and WS2 snaps back to its original shape, surrounding the post and protecting it form weed eater damage. The WS2 also has a self locking feature that holds it securely in place.

### DETAIL DESCRIPTION OF WS2

WS2 is generally made of 26 gauge sheet metal. To make a WS2 is simple. You take a strip of galvanized sheet metal, or any other material that can be strong and flexible enough. Next, bend the strip 4 times, creating a close square with four sides, with a flap. See FIG. 3. The flap is not connected which allow the user to flex open WS2, release and WS2 goes back to its original shape. See FIG. 2. There are also two folds, one fold on the flap folded in an outward direction. The other on the adjacent side folded in an inward direction which allow the user to connect together the flap and adjacent side, without the need if any other device such as a screw or nail. See FIGS. 2 and 3. When completed, you should have a rectangular piece of galvanized sheet metal that has a flap on one side with a fold outward. That can be flexed open and closed over and over again and locked together securely with the inward fold of the adjacent side.

### BRIEF DESCRIPTION OF DRAWING

FIG. 1 shows an open WS2.

FIG. 2 shows a closed WS2.

FIG. 3 shows a top view of a WS2 open.

FIG. 4 shows a top view of a WS2 closed.

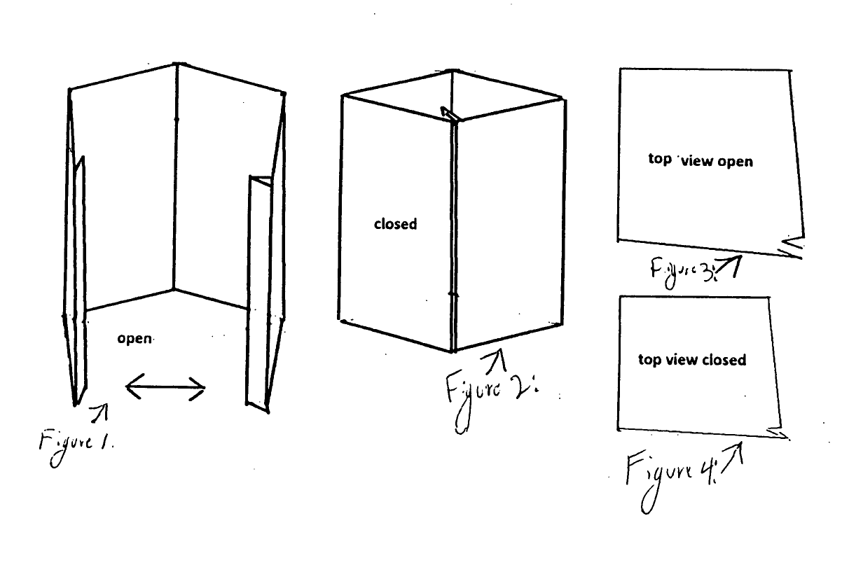

1. The WS2 claims to be similar, almost the same as the original Whipstop, with the added feature of the self locking system. This eliminates the need for screws or nails or any other means to secure the WS2 in place around a wooden post. WS2 claims to be a flexible wooden post protector that is comprised of a rust resistant extremely flexible galvanized sheet metal or other material that is bent into its final shape which is a rectangular shape that is folded into four sides. At one of the four corners the metal is not connected but left open so WS2 can be flexed open and stretched around a wooden post. WS2 claims to have one of the four sides with a flap and a small outward fold and the adjacent side has a small inward fold. The two folds are designed to connect together the open corner of WS2. Making WS2 one secure unit. This eliminates the need for screws or nails to hold WS2 securely around the wooden post. WS2 claims to be user friendly. The user simply flexes open WS2 and places it around a wooden post. WS2 snaps back to its original shape, the user simply hooks together the two adjacent folds and WS2 becomes one locked unit around the wooden post. WS2 claims there is no need for screws or nails to hold WS2 in place.
